(19) United States
(12) Patent Application Publication
(10) Pub. No.: US 2006/0112192 A1
(43) Pub. Date: May 25, 2006

(54) Method and apparatus to facilitate universal plug and play interaction between different local networks

(75) Inventors: Daniel F. Stewart, Hoffman Estates, IL (US); Jay R. Almaula, Bartlett, IN (US); Pekin E. Eren, Arlington Heights, IL (US); Steven K. Rossi, Schaumburg, IL (US); Joseph F. Wodka, Hoffman Estates, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Motorola, Inc.

(21) Appl. No.: 10/997,444

(22) Filed: Nov. 24, 2004

(51) Int. Cl. G06F 15/16

(52) U.S. Cl. 709/249

(57) ABSTRACT

A Universal Plug and Play relationship is established between platforms that comprise parts of separate local networks. A link is provided via that Universal Plug and Play relationship to then facilitate Universal Plug and Play-compatible communications as between elements that do not, in fact, share a common local network.

### RELATED APPLICATIONS

This application relates, in part, to attorney's docket number CML01836EV entitled HOME NETWORK BRIDGE-BASED COMMNICATIONS METHOD AND APPARATUS and filed on even date herewith, the contents of which are incorporated herein by this reference.

### TECHNICAL FIELD

This invention relates generally to networked communications and more particularly to Universal Plug and Play-based communications as between the platforms of two discrete local networks.

### BACKGROUND

Local communication networks of various kinds are known. In recent times, residential home networks are being installed in increasing numbers. Such home networks are facilitating the use of a variety of devices that source and/or utilize various kinds of digital content including such devices as a media server and/or receiver. In particular, home networks are proving to be a powerful and convenient way to share various kinds of digital content (such as music, video, and still images) at various locations throughout a given residence.

Such capabilities and functionality are driven, in part, through the use of Universal Plug and Plug (UPnP) as specified by the UPnP Forum at UPnP Device Architecture 1.0 version 1.0.1 (the full contents of which are incorporated herein). The UPnP set of protocols facilitates platform discovery, description, and control to thereby allow devices in a local privately addressed network to easily find one another, to discover their respective capabilities, and to readily permit and facilitate sharing of digital content as between such devices. While powerful and successful, however, UPnP's protocols are limited by design to only a single subnet. While quite adequate to serve the needs of devices that share a common local network (such as a residential local network), this limitation effectively prohibits the extension of UPnP-compatible exchanges to internetwork sessions.

At present, communications are possible as between two such home networks, but those communications remain relatively limited with respect to supported capabilities. As one simple example, it is relatively difficult to logically connect two home networks in a manner that permits digital content on one home network to be readily and conveniently shared with the elements that comprise the other home network. Easy and convenient content sharing as described earlier continues to remain relatively limited to the confines of a single home network.

### BRIEF DESCRIPTION OF THE DRAWINGS

The above needs are at least partially met through provision of the method and apparatus to facilitate universal plug and play interaction between different local networks as described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention;

FIG. 3 comprises a block diagram as configured in accordance with various embodiments of the invention; and

FIG. 4 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, one establishes a Universal Plug and Play relationship with at least one platform that comprises a part of a local network and then provides a link via that Universal Plug and Play relationship to a second platform, which second platform is both Universal Plug and Play compatible and external to the local network. In a preferred approach, an external network gateway serves to establish this Universal Plug and Play relationship.

To facilitate such steps, characterizing information for Universal Plug and Play-compatible platforms as are a part of a first local network are identified and resultant corresponding information is transmitted to a second local network, which second local network is different than the first local network. The second local network uses this information to provide a Universal Plug and Play view of the first local network Universal Plug and Play-compatible platforms in the second local network.

So configured, these actions support Universal Plug and Play interactions as though the platforms of the first and second local networks were present within a common local network. Devices of differing local networks are then able to utilize their native Universal Plug and Play capability, without modification or alteration, to effect compatible exchanges in a transparent and efficient manner. This, in effect, greatly leverages the existing capabilities of Universal Plug and Play-compatible devices in a highly cost effective manner.

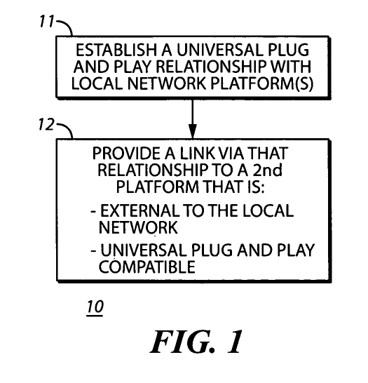

These and other benefits may become clearer upon making a thorough review and study of the following detailed description. Referring now to the drawings, and in particular to FIG. 1, a representative process 10 establishes 11 a Universal Plug and Play relationship with at least one platform that comprises a part of a local network and then provides 12 a link via that Universal Plug and Play relationship to a second platform. In a preferred approach, that second platform is both external to the present local network and is, itself, Universal Plug and Play compatible.

In a typical embodiment, this process 10 will facilitate establishment 11 of a Universal Plug and Play relationship with one or more platforms as comprise a part of the local network (via, for example, a virtual private network link). These platforms can be many and varied, including but not limited to personal computers, media servers and receivers, database servers, and so forth. In many cases establishment 11 of this relationship will comprise use of an external network gateway for the local network. In other cases, establishment 11 of this relationship can comprise using a platform that comprises a part of the local network and that is configured on a local network side of an external network gateway. (Such external network gateways are well known in the art and require no further elaboration here.)

There are various ways and means by which such a relationship can be so established as will be well understood by those skilled in the art. For the interested reader, some additional details in this regard may be found in the aforementioned home network bridge-based communications method and apparatus patent application. Since the present teachings are not especially sensitive to a particular methodology with respect to establishing such a relationship, further details in that regard are not presented here for the sake of brevity and the preservation of focus.

When providing 12 a link via the Universal Plug and Play relationship, the process 10 preferably provides the local network platform with a Universal Plug and Play view of the second platform. More particularly, and again preferably, this Universal Plug and Play view of the second platform causes the second platform to appear to be a part of the local network. As will be described below in more detail, this link can also serve to provide such a second platform with a Universal Plug and Play view of at least one platform as comprises a part of the local network, again so that this at least one platform itself appears to be a part of the local network that comprises the second platform.

So configured, the respective platforms of these distinct local networks are able to share digital content with one another via their Universal Plug and Play capabilities.

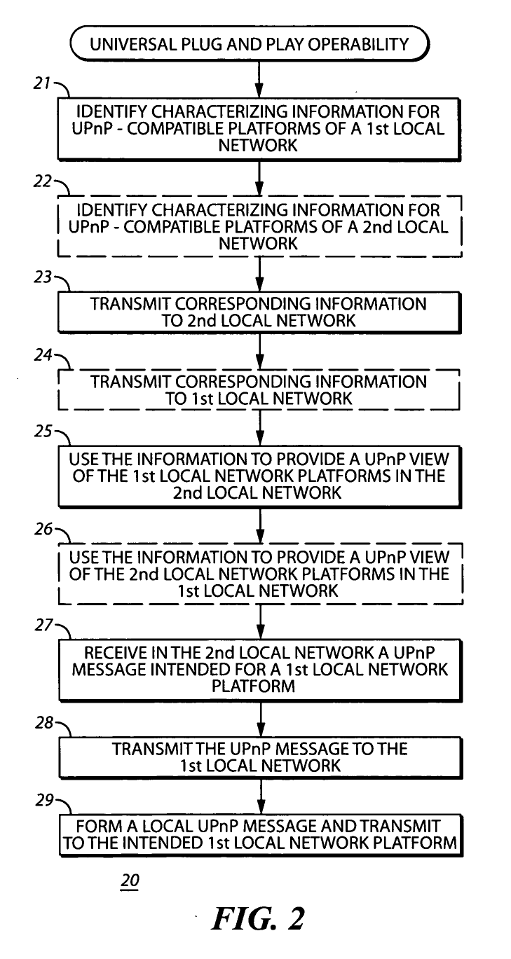

Referring now to FIG. 2, additional detail regarding a process 20 to permit use of Universal Plug and Play operability as between platforms that are located in different local networks will be described. This process 20 first facilitates identification 21 of characterizing information for Universal Plug and Play-compatible platforms as are a part of a first local network (information such as, but not limited to, unique identifier information (such as a Unique Service Name (USN)), device descriptions, service descriptions, and so forth). In a preferred, though optional, approach, this process 20 similarly also identifies 22 characterizing information for Universal Plug and Play-compatible platforms as are a part of a second local network. Such identification can be locally carried out, for example, via an external network gateway for the respective local networks (those skilled in the art will recognize that external network gateways are typically at least partially programmable platforms and hence can be readily programmed to accord with these teachings).

This process 20 then provides for transmission 23 of information that corresponds to the characterizing information to a second local network that is different than the first local network. By one approach, this information can correspond, one-to-one, with the characterizing information itself. By another approach, the transmitted information can comprise a subset, or a translated set, of the characterizing information. Again, in a preferred but optional deployment, this transmission 23 will be matched by a corresponding transmission 24 from the second local network to the first local network. So configured, for example, an external network gateway for the first local network can transmit its information to the external network gateway for the second local network, and vice versa.

The transmitted information is then used 25 to provide a Universal Plug and Play view in the second local network of the corresponding Universal Plug and Play-compatible platforms as are a part of the first local network. Similarly, in a preferred but optional approach, the information transmitted from the second local network to the first local network is used 26 to provide a Universal Plug and Play view in the first local network of the Universal Plug and Play-compatible platforms as are a part of the second local network.

Such a process 20 readily facilitates supporting a Universal Plug and Play interaction as between a second local network platform in the second local network and the Universal Plug and Play view of a particular one of the Universal Plug and Play-compatible platforms as is a part of the first local network. In particular, this process 20 facilitates supporting such Universal Plug and Play interactions as though the second local network platform and the particular one of the Universal Plug and Play-compatible platforms are present within a common local network.

To illustrate, and with continued reference to FIG. 2, this process 20 will support reception 27, in the second local network (for example, at the external network gateway for the second local network), a Universal Plug and Play message intended for a given one of the Universal Plug and Play-compatible platforms as is a part of the first local network, transmission 28 of information as corresponds to the Universal Plug and Play message to the first local network (for example, to the external network gateway for the first local network), and use (by, for example, the external network gateway for the first local network) of that information to form 29 a local Universal Plug and Play message and transmission thereof to the given one of the Universal Plug and Play-compatible platforms as is a part of the first local network.

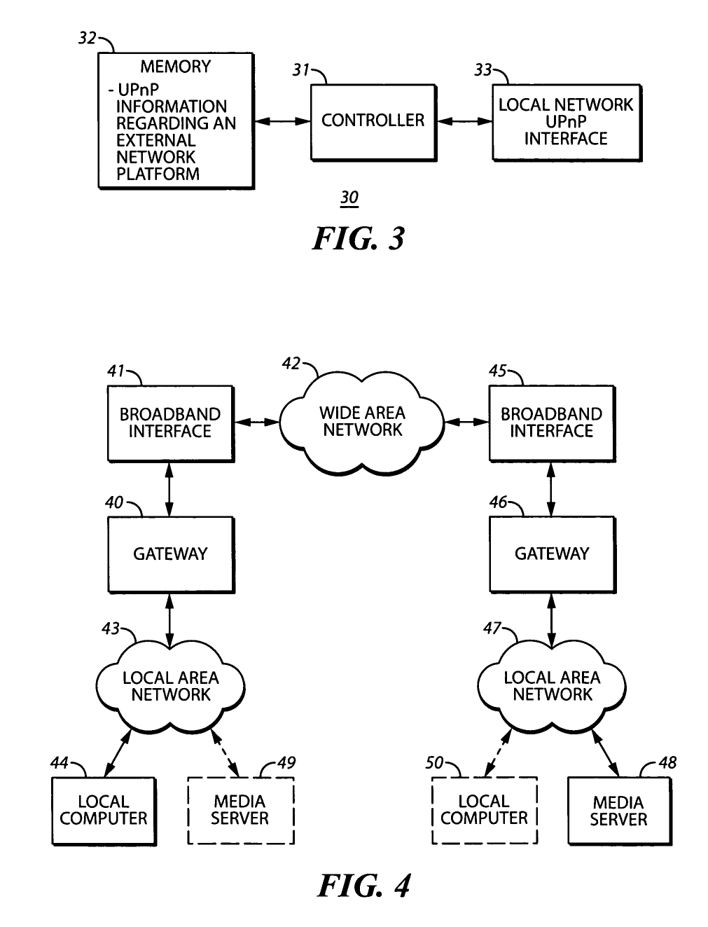

Such processes are supportable in any of a variety of ways (both presently known and likely developed hereafter). In general, and referring now to FIG. 3, an enabling apparatus 30 will preferably comprise a controller 31 that operably couples to a memory 32 and a local network Universal Plug and Play interface 33. The memory 32 will preferably have stored therein Universal Plug and play compatible information regarding one or more Universal Plug and Play-compatible platforms that comprise a part of an external network that is not a part of the local network that includes the apparatus 30 as described above.

The controller 31 in turn provides the Universal Plug and Play view as described above of one or more Universal Plug and Play-compatible platforms that comprise a part of an external network that is not a part of the local network to one or more platforms as comprise the local network via a Universal Plug and Play relationship. So arranged and configured, the controller 31 presents a view of the Universal Plug and Play-compatible platforms that comprise a part of an external network that appears, to the local network platforms, as though the external network platforms comprise a part of the local network.

In a preferred embodiment, this apparatus 30 comprises an external network gateway, though other configurations are possible. For example, the apparatus can comprise another part of the local network that is otherwise configured on a local network side of such an external network gateway.

With reference now to FIG. 4, a general illustration of these teachings in a deployed setting will be described. In this example, an external network gateway 40 couples via a broadband interface 41 of choice (i.e., a cable modem or the like) to a wide area network 42 such as the Internet. The external network gateway 40 facilitates communications via that wide area network 42 with a corresponding local area network 43 that comprises, at least in part and in this example, a local computer 44. In this example, a second local network also features an external network gateway 46 that couples to the wide area network 42 via a corresponding broadband interface 45 and to a local area network 47 that comprises, at least in part, a media server 48.

In this example, both the local computer 44 and the media server 48 comprise Universal Plug and Play-compatible devices. As such, they can readily engage in Universal Plug and Play sessions with other compatible devices within their own respective local networks. Pursuant to the teachings presented herein, the first external network gateway 40 utilizes the information as corresponds to the characterizing information for the media server 48 to effectively present a surrogate media server 49 within the context and subnet of the first local area network 43.

So configured, the local computer 44 can engage in all ordinary Universal Plug and Play actions with the media server 49. In this case, however, the Universal Plug and Play messages that target the surrogate media server 49 are received by the first external network gateway 40 and forwarded on to the second external network gateway 46. The latter then forwards the Universal Plug and Play message to the actual media server 48. The latter can then respond by basically reversing this process. In this way, these two devices can successfully engage in all ordinary Universal Plug and Play activities notwithstanding that they do not share a common local area network. To facilitate such actions, the external network gateways are preferably capable of performing network layer Internet Protocol address masquerading; that is, the gateway (or other device of choice) can masquerade as multiple devices at the Internet Protocol network layer on the local network as correspond to devices on the remote network.

In the illustrative examples provided above, gateways serve in large part to facilitate the described proxy-like/masquerading functionality. If desired, however, such functionality can be based elsewhere (or can be distributed over a plurality of enabling platforms). For example, a first local computer 44 as comprises a part of the first local area network 43 and a second local computer 50 as comprises a part of the second local area network 47 could serve as the enabling platforms by effecting the various actions and reactions set forth herein.

Those skilled in the art will appreciate that these teachings essentially serve to couple two separate subnets to permit and facilitate Universal Plug and Play communications between devices serviced within such separate subnets. The external network gateways described above, or other enabling platforms of choice, serve both as a Universal Plug and Play control point and as a Universal Plug and Play device.

Schematically, a first enabling device for a home local area network can act as a control point and source an M_SEARCH message to identify Universal Plug and Play devices within its home local area network. Universal Plug and Play devices (such as a first device A and a second device B) can respond with their LOCATION uniform resource locator, their search target set, and their Unique Service Name (USN) set to their universally unique identifier. The first enabling device can parse the LOCATION header as corresponds to these responding devices to derive their corresponding Internet Protocol address and home local area network port number. In a preferred approach the home enabling device stores this characterizing information, thereby creating a mapping between the universally unique identifier and Internet Protocol address and port for each such responding device.

The home enabling device can then create a message from these devices (i.e., device A and B in this example) and transmit that message to a remote enabling device as serves a remote local area network. This message preferably contains all of the characterizing information as was received from the Universal Plug and Play responding devices. This remote enabling device then obtains a mapping of the remote-to-local Internet Protocol address or, if not available, itself obtains a new Internet Protocol address for each device it now knows exists in the home local area network. (Such information can be derived, for example, by examining the universally unique identifier of each such message as is received from the home enabling device.)

The remote enabling device then creates a table that maps the home local area network domain addresses of the responding devices (i.e., device A and B in this example) to the newly obtained local addresses within the remote local area network. Following this, the remote enabling device creates advertisement messages (using, for example, NOTIFY with ssdp:alive) for the remote local area network domain that features local addresses within that remote local area network domain for each search target it received from the home enabling device.

The remote local area network control point receives this message with a LOCATION header that presents a local Internet Protocol address owned by the remote enabling device. This control point then sources a hyper text transfer protocol GET message to the remote enabling device at one of the newly obtained Internet protocol addresses while essentially having the understanding and perception that it is communicating with, for example, device A of the home local area network. The remote enabling device can use its table to exchange the local Internet Protocol address with the Internet Protocol address that device A uses within the home local area network. The remote enabling device encapsulates the hypertext transfer protocol message with the Internet Protocol address changed to reflect device A's local address and transmits the result to the home enabling device.

The latter receives the hypertext transfer protocol GET message and ascertains that the source address is a local address within the remote local area network. The home enabling device uses the mapping of the remote-to-local Internet Protocol address (or, if not available, obtains a new Internet Protocol address using an approach such as dynamic host configuration protocol) to use in the remote-to-local mapping. The device then creates a table with the home local area network Internet Protocol address mapping to the corresponding remote local area network Internet Protocol address. The home enabling device then creates a hypertext transfer protocol GET message using the newly obtained remote local area network address mapping and transmits the result, in this example, to device A.

Device A, upon receiving this message, can respond with an extensible markup language description and transmit it to the home enabling device, perceiving, as those skilled in the art will understand, that it is communicating with the remote control point noted above. The home enabling device will receive this message to ascertain whether the extensible markup language to ensure that the uniform resource locator base tag is empty. When empty, it will preferably change the destination Internet Protocol address to the remote local area network address for the remote control point, encapsulate the message, and forward it to the remote enabling device. When not empty, it will preferably change both the uniform resource locator base and the destination Internet Protocol address, encapsulate the message, and send it to the remote enabling device. Upon receiving the encapsulated message, the remote enabling device can change the source Internet Protocol address to the corresponding local Internet Protocol address that represents device A in the remote local area network and forward the message to the remote control point.

Those skilled in the art will appreciate that, so deployed and configured, Universal Plug and Play messages are readily sent back and forth over the connection between the two enabling devices

Those skilled in the art will also recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method for use in a local network comprising:
establishing a Universal Plug and Play relationship with at least one platform that comprises a part of the local network;
providing a link via that Universal Plug and Play relationship to a second platform, which second platform is:
external to the local network;
Universal Plug and Play compatible.

2. The method of claim 1 wherein establishing a Universal Plug and Play relationship with at least one platform that comprises a part of the local network further comprises establishing a Universal Plug and Play relationship with a plurality of platforms that each comprise a part of the local network.

3. The method of claim 1 wherein establishing a Universal Plug and Play relationship with at least one platform that comprises a part of the local network further comprises using an external network gateway to establish the Universal Plug and Play relationship.

4. The method of claim 1 wherein establishing a Universal Plug and Play relationship with at least one platform that comprises a part of the local network further comprises using a platform to establish the Universal Plug and Play relationship that:
comprises a part of the local network;
is configured on a local network side of an external network gateway.

5. The method of claim 1 wherein providing a link further comprises providing the at least one platform with a Universal Plug and Play view of the second platform.

6. The method of claim 5 wherein providing the at least one platform with a Universal Plug and Play view of the second platform further comprises providing the at least one platform with a Universal Plug and Play view of the second platform such that the second platform appears to be a part of the local network.

7. The method of claim 1 wherein providing a link further comprises providing the second platform with a Universal Plug and Play view of the at least one platform.

8. The method of claim 7 wherein providing the second platform with a Universal Plug and Play view of the at least one platform further comprises providing the second platform with a Universal Plug and Play view of the at least one platform such that the at least one platform appears to be a part of a local network that comprises the second platform but not the at least one platform.

9. An apparatus for use with a local network comprising:
a memory having stored therein Universal Plug and Play-compatible information regarding a Universal Plug and Play-compatible platform that comprises a part of an external network that is not a part of the local network;
a local network Universal Plug and Play interface;
a controller that is operably coupled to the memory and to the local network Universal Plug and Play interface, such that the controller provides a Universal Plug and Play view of the Universal Plug and Play-compatible platform that comprises a part of an external network that is not a part of the local network to at least one platform as comprises a part of the local network via a Universal Plug and Play relationship.

10. The apparatus of claim 9 wherein the apparatus comprises an external network gateway.

11. The apparatus of claim 9 wherein the apparatus comprises a part of the local network and that is configured on a local network side of an external network gateway.

12. The apparatus of claim 9 wherein the controller further comprises means for presenting a Universal Plug and Play view of the Universal Plug and Play-compatible platform that comprises a part of an external network that is not a part of the local network such that the Universal Plug and Play-compatible platform that comprises a part of an external network that is not a part of the local network appears to the at least one platform as comprises a part of the local network as being a part of the local network.

13. The apparatus of claim 9 wherein the controller further comprises means for providing information to the external network that is not a part of the local network such that the at least one platform has a Universal Plug and Play presence in the external network that is not a part of the local network.

14. A method to permit a use of Universal Plug and Play operability as between platforms that are located in different local networks, comprising:
identifying characterizing information for Universal Plug and Play-compatible platforms as are a part of a first local network;
transmitting information that corresponds to the characterizing information to a second local network, which second local network is different than the first local network;
using the information to provide a Universal Plug and Play view in the second local network of the Universal Plug and Play-compatible platforms as are a part of the first local network.

15. The method of claim 14 and further comprising:
receiving, in the second local network, a Universal Plug and Play message intended for a given one of the Universal Plug and Play-compatible platforms as is a part of the first local network.

16. The method of claim 15 and further comprising:
transmitting information that corresponds to the Universal Plug and Play message to the first local network.

17. The method of claim 16 and further comprising:
using the information that corresponds to the Universal Plug and Play message to form a local Universal Plug and Play message;
transmitting the local Universal Plug and Play message to the given one of the Universal Plug and Play-compatible platforms as are a part of the first local network.

18. The method of claim 14 and further comprising:
identifying characterizing information for Universal Plug and Play-compatible platforms as are a part of second local network;
transmitting information that corresponds to the characterizing information to the first local network;
using the information to provide a Universal Plug and Play view in the first local network of the Universal Plug and Play-compatible platforms as are a part of the second local network.

19. The method of claim 14 and further comprising:
supporting a Universal Plug and Play interaction between a second local network platform in the second local network and the Universal Plug and Play view of a particular one of the Universal Plug and Play-compatible platforms as are a part of the first local network.

20. The method of claim 19 and further comprising:
supporting the Universal Plug and Play interaction as though the second local network platform and the particular one of the Universal Plug and Play-compatible platforms were present within a common local network.
